(19) United States
(12) Patent Application Publication
(10) Pub. No.: US 2022/0005233 A1
(43) Pub. Date: Jan. 6, 2022

(54) ENCODING APPARATUS, DECODING APPARATUS, ENCODING SYSTEM, LEARNING METHOD AND PROGRAM

(71) Applicant: NIPPON TELEGRAPH AND TELEPHONE CORPORATION, Tokyo (JP)

(72) Inventors: Shinobu KUDO, Musashino-shi (JP); Shota ORIHASHI, Musashino-shi (JP); Masaki KITAHARA, Musashino-shi (JP); Atsushi SHIMIZU, Musashino-shi (JP)

(73) Assignee: NIPPON TELEGRAPH AND TELEPHONE CORPORATION, Tokyo (JP)

(21) Appl. No.: 17/292,617

(22) PCT Filed: Sep. 24, 2019
(86) PCT No.: PCT/JP2019/037254

§ 371 Date: May 10, 2021

(30) Foreign Application Priority Data
Nov. 14, 2018 (JP) 2018-213791

(51) Int. Cl. G06T 9/00; G06T 7/62; G06N 3/08

(52) U.S. Cl. CPC G06T 9/002; G06N 3/08; G06T 7/62

(57) ABSTRACT

An encoding apparatus encodes an input image and includes: a provisional encoded data acquisition unit configured to obtain provisional encoded data which has a size greater than a target size of encoded data which is data obtained by encoding the image based on the image and a parameter for determining the target size; and an encoded data acquisition unit configured to obtain the encoded data by converting data within a data range outside of a data range corresponding to the target size in the provisional encoded data into a predetermined value. The provisional encoded data acquisition unit obtains the provisional encoded data so that features for determining the image are contained more within the data range corresponding to the target size than in the data range outside of the data range corresponding to the target size.

### TECHNICAL FIELD

The present invention relates to an encoding apparatus, a decoding apparatus, an encoding system, a learning method, and a program.

Priority is claimed on Japanese Patent Application No. 2018-213791, filed Nov. 14, 2018, the content of which is incorporated herein by reference.

### BACKGROUND ART

As a method of encoding data to be encoded such as an image, there is a method in which an autoencoder (a self-encoder) is used. An autoencoder includes an encoder that obtains a feature amount from input data and a decoder that obtains data close to the input data from the feature amount. The encoder and the decoder are constructed of any arithmetic units. For example, when the input data is an image, the encoder is configured by combining a plurality of arithmetic units and nonlinear converters performing convolution operations. The decoder is configured by combining a plurality of arithmetic units and nonlinear converters performing inverse operations of the convolution operation performed by the encoder.

In general, when a system is designed using a neural network including an autoencoder, it is necessary to determine a configuration of the neural network (for example, the number of layers, the number of units, the kinds of activation functions, an output size, and the like) in advance. For example, an autoencoder that has a size of X×Y×Z and accepts image data with 1-pixel bit accuracy of B bits as an input will be described. Here, X, Y, and Z are a width, a height, and the number of channels of each image, respectively. When an output size of the encoder is set to X′×Y′×Z′ and the bit accuracy of one element is set to B′ bits, a compression ratio and an encoded data size are uniquely determined. The encoded data size is expressed as X′×Y′×Z′×B′ and the compression ratio is expressed as (X′×Y′×Z′×B′)/(X×Y×Z×B). Thus, an encoder of the autoencoder cannot perform encoding with only one encoded data size and one compression ratio for one neural network. Therefore, to perform encoding with any compression size, it is necessary to design each neural network for each of a plurality of encoded data sizes.

However, it is not practical to design and operate a plurality of neural networks from the viewpoint of a memory capacity, system mounting, or the like. Accordingly, several schemes have been proposed. For example, according to a technology described in Non-Patent Literature 1, an input image is input to an autoencoder, a difference image between an output decoded image and the input image is calculated, and a difference image is input to the autoencoder again to obtain a decoded difference image. According to this technology, the foregoing processes are repeated until a necessary encoded data size is obtained. Thus, according to this technology, the encoded data size is controlled with an encoded data size which is double an encoded data size in the designed neural network. For example, according to a technology disclosed in Non-Patent Literature 2, a code amount map indicating a code amount (quantization accuracy) allocated to each element of an encoder output is generated apart from the encoded data. According to this technology, the code amount is controlled by transmitting the generated encoding map along with the encoded data.

### CITATION LIST

### Non-Patent Literature

[Non-Patent Literature 1] G. Toderici et al., “Full Resolution Image Compression with Recurrent Neural Networks,” arXiv, 7 Jul. 2017.

[Non-Patent Literature 2] M. Li et al., “Learning Convolutional Networks for Content-weighted Image Compression,” arXiv, 19 Sep. 2017.

### SUMMARY OF INVENTION

### Technical Problem

In the technology described in Non-Patent Literature 1, the encoded data size cannot be controlled with only the encoded data size which is double the encoded data size in the designed neural network. Therefore, to perform detailed control, it is necessary to design an encoded data size which is small in the neural network. In this case, an encoding process and a decoding process have to be performed many times until a desired encoded data size is obtained. Therefore, the technology described in Non-Patent Literature 1 has a problem that a processing time increases. In the technology described in Non-Patent Literature 2, the code amount map may become extra overhead. Therefore, the technology described in Non-Patent Literature 2 has a problem that encoding efficiency deteriorates more than in the neural network in which an encoded data size is fixed.

The present invention has been devised in view of such circumstances and an objective of the present invention is to provide a technology capable of compressing the size of data to a desired size while suppressing an increase in a processing time and deterioration in encoding efficiency.

### Solution to Problem

According to an aspect of the present invention, an encoding apparatus encodes an input image and includes a provisional encoded data acquisition unit configured to obtain provisional encoded data which has a size greater than a target size of encoded data which is data obtained by encoding the image based on the image and a parameter for determining the target size; and an encoded data acquisition unit configured to obtain the encoded data by converting data within a data range outside of a data range corresponding to the target size in the provisional encoded data into a predetermined value. The provisional encoded data acquisition unit obtains the provisional encoded data so that features for determining the image are contained more within the data range corresponding to the target size than in the data range outside of the data range corresponding to the target size.

In the encoding apparatus according to the aspect of the present invention, a value of the parameter may be a code amount or a compression ratio.

In the encoding apparatus according to the aspect of the present invention, the encoded data acquisition unit may delete the data within the data range outside of the data range corresponding to the target size in the provisional encoded data and sets data from which the data is deleted as the encoded data to be decoded.

According to another aspect of the present invention, a decoding apparatus decodes an encoded image encoded by an encoding apparatus that acquires provisional encoded data which has a size greater than a target size of encoded data which is data obtained by encoding a first image based on the first image and a parameter for determining the target size and contains more features for determining the first image within a data range corresponding to the target size than a data range outside of the data range corresponding to the target size, and obtains the encoded data by converting data within the data range outside of the data range corresponding to the target size in the provisional encoded data into a predetermined value. The decoding apparatus includes a decoded image acquisition unit configured to obtain a decoded image from encoded data corresponding to a second image different from the first image based on the encoded data and the parameter.

According to still another aspect of the present invention, an encoding system includes: a feature amount extraction learning unit configured to learn extraction of a feature amount which is a based on an image and a parameter for determining a target size of encoded data which is data obtained by encoding the image so that features for determining the image are contained more in a data range corresponding to the target size than in a data range having a size greater than the target size and being outside of the data range corresponding to the target size; a conversion unit configured to obtain a conversion feature amount by converting data within the data range outside of the data range corresponding to the target size into a predetermined value with regard to the feature amount; and a decoding learning unit configured to learn reconfiguration of the image so that a decoded image determined to be the same image as the image is obtained based on the conversion feature amount and the parameter.

According to still another aspect of the present invention, an encoding apparatus encodes input data to be encoded and includes a provisional encoded data acquisition unit configured to obtain provisional encoded data which has a size greater than a target size of encoded data which is data obtained by encoding the data to be encoded based on the data to be encoded and a parameter for determining the target size; and an encoded data acquisition unit configured to obtain the encoded data by converting data within a data range outside of a data range corresponding to the target size in the provisional encoded data into a predetermined value. The provisional encoded data acquisition unit obtains the provisional encoded data so that features for determining the data to be encoded are contained more within the data range corresponding to the target size than in the data range outside of the data range corresponding to the target size.

According to still another aspect of the present invention, a learning method includes: learning extraction of a feature amount which is a based on an image and a parameter for determining a target size of encoded data which is data obtained by encoding the image so that features for determining the image are contained more in a data range corresponding to the target size than in a data range having a size greater than the target size and being outside of the data range corresponding to the target size; obtaining a conversion feature amount by converting data within the data range outside of the data range corresponding to the target size into a predetermined value with regard to the feature amount; and learning reconfiguration of the image so that a decoded image determined to be the same image as the image is obtained based on the conversion feature amount and the parameter.

According to still another aspect of the present invention, a program causes a computer to function as the encoding apparatus or the decoding apparatus.

### Advantageous Effects of Invention

According to the present invention, it is possible to compress the size of data to a desired size while suppressing an increase in a processing time and deterioration in encoding efficiency.

### BRIEF DESCRIPTION OF DRAWINGS

FIG. 1 is a block diagram illustrating a functional configuration of an encoding apparatus 100 according to an embodiment of the present invention.

FIG. 2 is a block diagram illustrating a functional configuration of a feature amount extraction unit 110 of the encoding apparatus 100 according to the embodiment of the present invention.

FIG. 3 is a block diagram illustrating a functional configuration of a decoding apparatus 200 according to the embodiment of the present invention.

FIG. 4 is a block diagram illustrating a functional configuration of a reconfiguration unit 240 of the decoding apparatus 200 according to the embodiment of the present invention.

FIG. 5 is a flowchart illustrating an operation of the encoding apparatus 100 according to the embodiment of the present invention.

FIG. 6 is a schematic diagram illustrating a flow of an encoding process performed by the encoding apparatus 100 according to the embodiment of the present invention.

FIG. 7 is a flowchart illustrating an operation of the decoding apparatus 200 according to the embodiment of the present invention.

FIG. 8 is a schematic diagram illustrating a flow of a decoding process performed by the decoding apparatus 200 according to the embodiment of the present invention.

FIG. 9 is a schematic diagram illustrating a flow of a learning process performed by the encoding apparatus 100 and the decoding apparatus 200 according to the embodiment of the present invention.

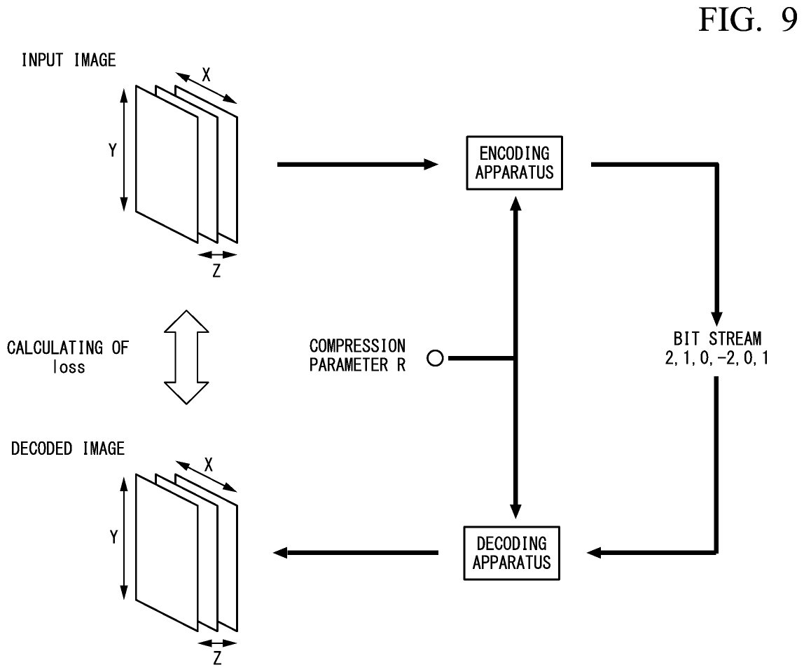

### DESCRIPTION OF EMBODIMENTS

### Embodiments

Hereinafter, embodiments of the present invention will be described with reference to the drawings. Hereinafter, for example, an encoding apparatus 100 that encodes image data and a decoding apparatus 200 that decodes the image data will be described. The encoding apparatus 100 and the decoding apparatus 200 to be described below can also be applied to encoding and decoding of data other than image data.

### [Configuration of Encoding Apparatus 100]

Hereinafter, a configuration of the encoding apparatus 100 will be described. The encoding apparatus 100 accepts an input image which is data to be encoded and compression parameter as an input and outputs a bit stream corresponding to the input image. The compression parameter are parameters for determining a target size of encoded data which is data obtained by encoding the input image.

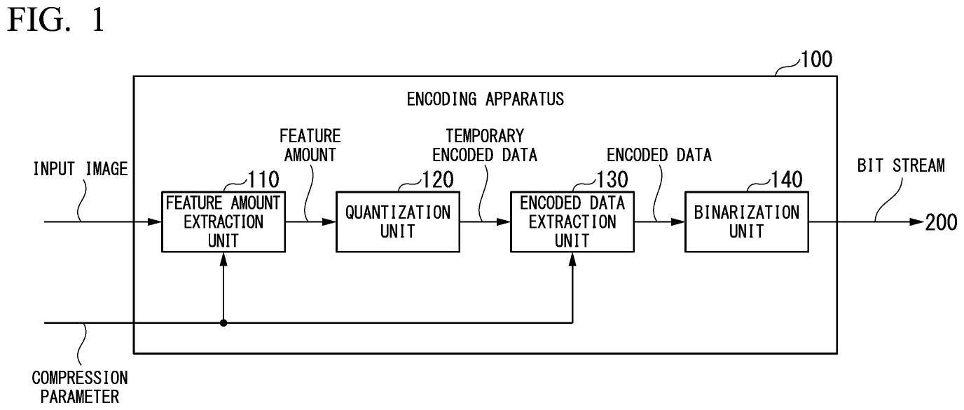

FIG. 1 is a block diagram illustrating a functional configuration of the encoding apparatus 100 according to an embodiment of the present invention. As illustrated in FIG. 1, the encoding apparatus 100 includes a feature amount extraction unit 110, a quantization unit 120, an encoded data extraction unit 130, and a binarization unit 140.

The feature amount extraction unit 110 acquires the input image and the compression parameter from an external device. The feature amount extraction unit 110 extracts a feature amount of the input image based on the acquired input image and compression parameter. Here, the feature amount extraction unit 110 performs extraction of the feature amount so that features of the input image are concentrated on a predetermined region and a magnitude based on the compression parameter. The predetermined region may be any region as long as the condition that the encoding side and the decoding side can share the predetermined region. For example, the predetermined region can be set in order from the head of the feature amount data. The condition may be transmitted from the encoding side to the decoding side. The feature amount extraction unit 110 outputs information indicating the extracted feature amount to the quantization unit 120.

The quantization unit 120 (a temporary encoded data acquisition unit) acquires the information output from the feature amount extraction unit 110. The quantization unit 120 performs a quantization process on the feature amount based on the acquired information and converts the feature amount into provisional encoded data (temporary encoded data). The quantization unit 120 outputs the generated provisional encoded data to the encoded data extraction unit 130.

The encoded data extraction unit 130 (an encoded data acquisition unit) acquires the provisional encoded data output from the quantization unit 120. The encoded data extraction unit 130 acquires the compression parameter from the external device. The encoded data extraction unit 130 extracts the encoded data based on the acquired provisional encoded data and compression parameter. The encoded data extraction unit 130 outputs the extracted encoded data to the binarization unit 140.

As described above, the feature amount extraction unit 110 performs extraction of the feature amount so that features of the input image are concentrated on the region and the magnitude based on the compression parameter. The encoded data extraction unit 130 performs a process of setting the size of the encoded data to a size based on the compression parameter, for example, a desired bit rate, by deleting a region except for the region.

The binarization unit 140 acquires the encoded data output from the encoded data extraction unit 130. The binarization unit 140 binarizes the acquired encoded data. The binarization unit 140 outputs the binarized encoded data as a bit stream to the external device.

### [Configuration of Feature Amount Extraction Unit 110]

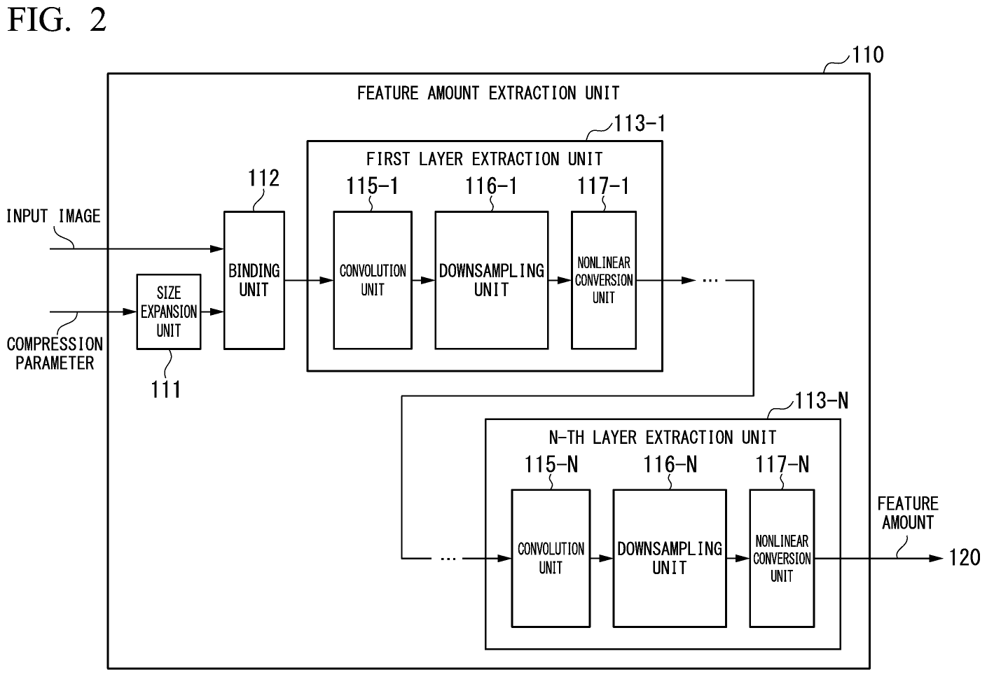

Hereinafter, a configuration of the feature amount extraction unit 110 will be described in detail. The feature amount extraction unit 110 includes, for example, a neural network (a combination of a convolution operation, downsampling, and nonlinear conversion) illustrated in FIG. 2.

FIG. 2 is a block diagram illustrating a functional configuration of the feature amount extraction unit 110 of the encoding apparatus 100 according to the embodiment of the present invention. As illustrated in FIG. 2, the feature amount extraction unit 110 includes a size expansion unit 111, a binding unit 112, and extraction units formed by N layers (a first layer extraction unit 113-1 to an N-th layer extraction unit 113-N). As illustrated in FIG. 2, the first layer extraction unit 113-1 to the N-th layer extraction unit 113-N respectively include a convolution unit 115-1, a downsampling unit 116-1, and a nonlinear conversion unit 117-1, . . . , and a convolution unit 115-N, a downsampling unit 116-N, and a nonlinear conversion unit 117-N.

The size expansion unit 111 acquires the compression parameter from the external device. The size expansion unit 111 performs a process of expanding the acquired compression parameter to the same size as the size of the input image. The size expansion unit 111 outputs the expanded compression parameter to the binding unit 112.

The binding unit 112 acquires the input image from the external device. The binding unit 112 acquires the expanded compression parameter output from the size expansion unit 111. The binding unit 112 performs a process of binding the acquired input image and the expanded compression parameter in a channel direction. The binding unit 112 outputs the input image bound with the expanded compression parameter to the convolution unit 115-1 of the first layer extraction unit 113-1.

The convolution unit 115-1 of the first layer extraction unit 113-1 acquires the input image output from the binding unit 112. The convolution unit 115-1 performs a convolution process on the acquired input image. The convolution unit 115-1 outputs the input image subjected to the convolution process to the downsampling unit 116-1.

The downsampling unit 116-1 acquires the input image output from the convolution unit 115-1. The downsampling unit 116-1 performs a process of downsampling the acquired input image. The downsampling unit 116-1 outputs the downsampled input image to the nonlinear conversion unit 117-1.

The nonlinear conversion unit 117-1 acquires the input image output from the downsampling unit 116-1. The nonlinear conversion unit 117-1 performs a process of performing a nonlinear conversion on each element of the acquired input image. The nonlinear conversion unit 117-1 outputs the input image subjected to the nonlinear conversion process to the convolution unit of the extraction unit in the subsequent layer.

The feature amount extraction unit 110 extracts the feature amount of the input image based on the acquired input image and compression parameter by performing the foregoing processes repeatedly from the first layer to the N-th layer. The nonlinear conversion unit 117-N of the N-th layer extraction unit 113-N outputs information indicating the extracted feature amount to the quantization unit 120.

### [Configuration of Decoding Apparatus 200]

Hereinafter, a configuration of the decoding apparatus 200 will be described. The decoding apparatus 200 accepts the bit stream as an input and outputs a decoded image corresponding to the input image.

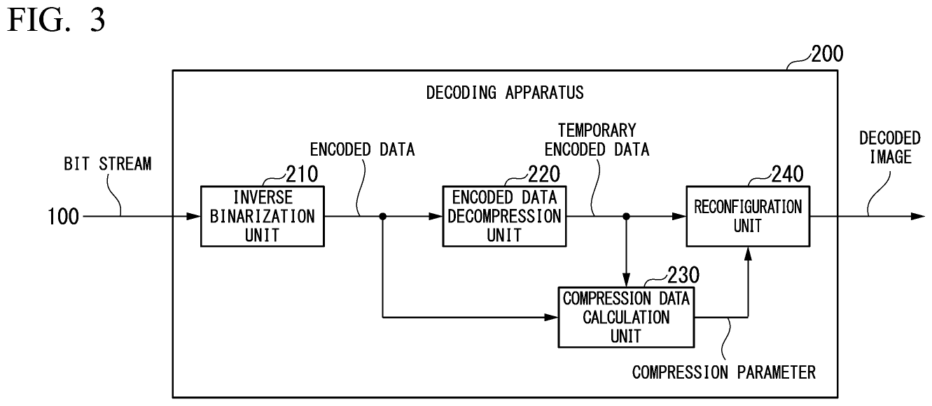

FIG. 3 is a block diagram illustrating a functional configuration of the decoding apparatus 200 according to the embodiment of the present invention. As illustrated in FIG. 3, the decoding apparatus 200 includes an inverse binarization unit 210, an encoded data decompression unit 220, a compression parameter calculation unit 230, and a reconfiguration unit 240.

The inverse binarization unit 210 acquires the bit stream from the external device. The inverse binarization unit 210 converts the acquired bit stream into the encoded data. The inverse binarization unit 210 outputs the generated encoded data to the encoded data decompression unit 220 and the compression parameter calculation unit 230.

The encoded data decompression unit 220 acquires the encoded data output from the inverse binarization unit 210. The encoded data decompression unit 220 generates the provisional encoded data by decompressing the number of elements of the acquired encoded data up to the same number of elements as those of the provision encoded data generated by the quantization unit 120 of the encoding apparatus 100. The encoded data decompression unit 220 outputs the generated provisional encoded data to the compression parameter calculation unit 230 and the reconfiguration unit 240.

The compression parameter calculation unit 230 acquires the encoded data output from the inverse binarization unit 210. The compression parameter calculation unit 230 acquires the provisional encoded data output from the encoded data decompression unit 220. The compression parameter calculation unit 230 calculates the compression parameter based on the acquired encoded data and provisional encoded data. The compression parameter calculation unit 230 outputs the calculated compression parameter to the reconfiguration unit 240.

The reconfiguration unit 240 (a decoded image acquisition unit) acquires the provisional encoded data output from the encoded data decompression unit 220. The reconfiguration unit 240 acquires the compression parameter output from the compression parameter calculation unit 230. The reconfiguration unit 240 reconfigures the decoded image based on the provision encoded data and the compression parameter. The reconfiguration unit 240 outputs the reconfigured decoded image to the external device.

### [Configuration of Reconfiguration Unit 240]

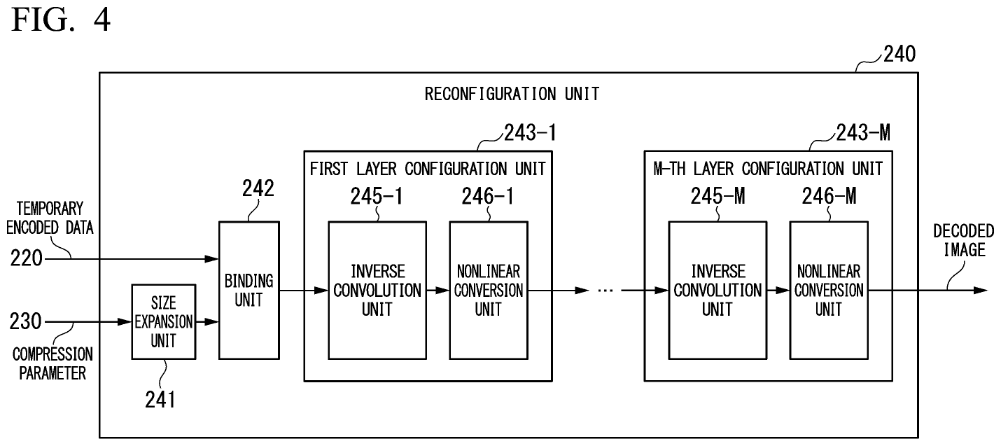

Hereinafter, a configuration of the reconfiguration unit 240 will be described in detail. The reconfiguration unit 240 includes, for example, a neural network (a combination of an inverse convolution operation and a nonlinear conversion) illustrated in FIG. 4.

FIG. 4 is a block diagram illustrating a functional configuration of the reconfiguration unit 240 of the decoding apparatus 200 according to the embodiment of the present invention. As illustrated in FIG. 4, the reconfiguration unit 240 includes a size expansion unit 241, a binding unit 242, configuration units formed by M layers (a first layer configuration unit 243-1 to an M-th layer configuration unit 243-M). As illustrated in FIG. 4, the first layer configuration unit 243-1, . . . , and the M-th layer configuration unit 243-M respectively include an inverse convolution unit 245-1, . . . , the inversion convolution unit 245-M, and an inverse convolution unit 246-1, . . . , the nonlinear conversion unit 246-M.

The size expansion unit 241 acquires the compression parameter output from the compression parameter calculation unit 230. The size expansion unit 241 performs a process of expanding the size of the acquired compression parameter up to the same size as that of the input image. The size expansion unit 241 performs a process of expanding the size of the compression parameter up to the same size as that of the input image by assigning a pre-decided value of “0” or the like. The size expansion unit 241 outputs the expanded compression parameter to the binding unit 242.

The binding unit 242 acquires the provisional encoded data from the encoded data decompression unit 220. The binding unit 112 acquires the expanded compression parameter output from the size expansion unit 241. The binding unit 242 performs a process of binding the acquired provisional encoded data and the expanded compression parameter in a channel direction. The binding unit 242 outputs the provisional encoded data bound with the expanded compression parameter to the inverse convolution unit 245-1 of the first layer configuration unit 243-1.

The inverse convolution unit 245-1 of the first layer configuration unit 243-1 acquires the provisional encoded data output from the binding unit 242. The inverse convolution unit 245-1 performs an inverse convolution process to the convolution process performed by the feature amount extraction unit 110 of the encoding apparatus 100. The inverse convolution unit 245-1 outputs the provisional encoded data subjected to the inverse convolution process to the nonlinear conversion unit 246-1.

The nonlinear conversion unit 246-1 acquires the provisional encoded data output from the inverse convolution unit 245-1. The nonlinear conversion unit 246-1 performs the nonlinear conversion process on each element of the acquired provisional encoded data. The nonlinear conversion unit 246-1 outputs the provisional encoded data subjected to the nonlinear conversion process to the inverse convolution unit of a subsequent layer configuration unit.

The reconfiguration unit 240 reconfigures the decoded image based on the acquired provisional encoded data and compression parameter by repeating the foregoing processes from the first layer to the M-th layer. The nonlinear conversion unit 246-M of the M-th layer configuration unit 243-M outputs the reconfigured decoded image to the external device.

As described above, the provisional encoded data transmitted from the encoding apparatus 100 is data that expresses only a region on which the features of the input image are concentrated. In other words, in order for the reconfiguration unit 240 of the decoding apparatus 200 to obtain the decoded image, it is necessary to supplement the region deleted by the encoded data extraction unit 130 of the encoding apparatus 100. Since the region deleted by the encoded data extraction unit 130 is not a feature of the input image, the size expansion unit 241 of the reconfiguration unit 240 of the decoding apparatus 200 assigns the pre-decided value of “0” or the like to the provisional encoded data, as described above, and thus the reconfiguration unit 240 can obtain the decoded image from the provisional encoded data.

### [Operation of Encoding Apparatus 100]

Hereinafter, an operation of the encoding apparatus 100 will be described giving a specific example.

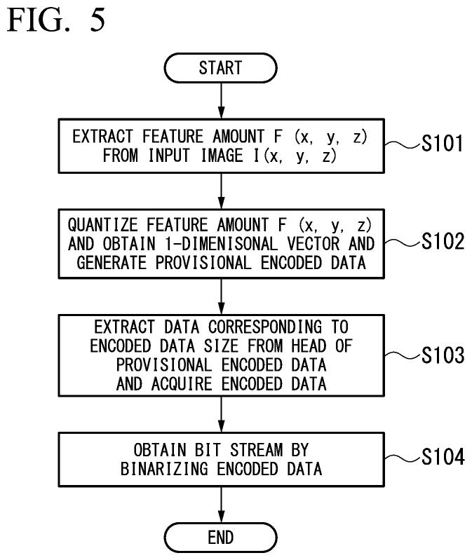

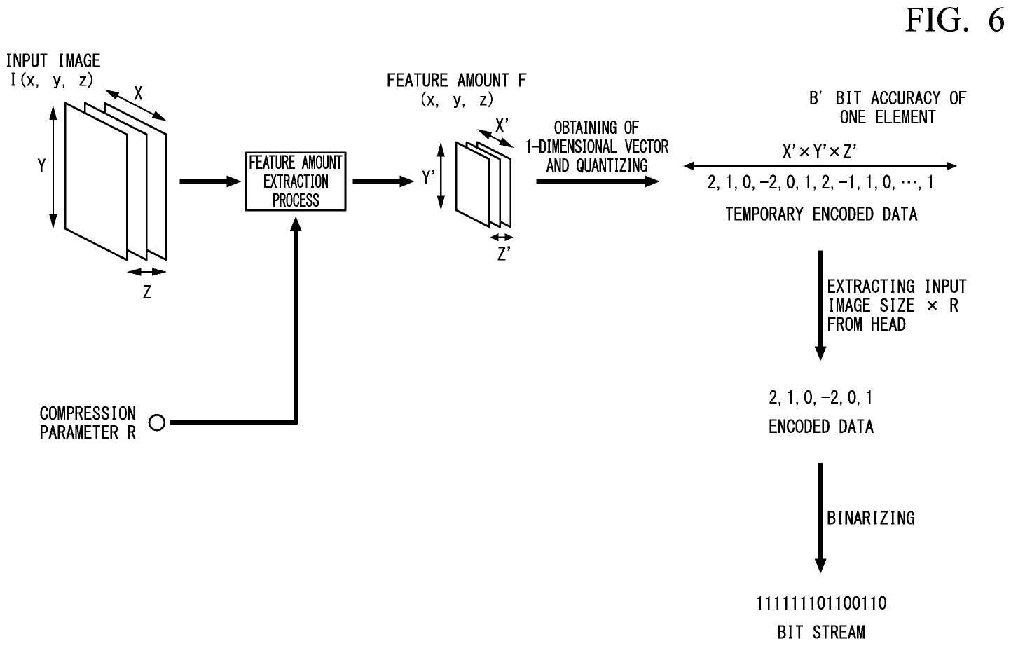

FIG. 5 is a flowchart illustrating an operation of the encoding apparatus 100 according to the embodiment of the present invention. FIG. 6 is a schematic diagram illustrating a flow of an encoding process performed by the encoding apparatus 100 according to the embodiment of the present invention.

First, the input image to be encoded is defined to I(x, y, z) and the compression parameter is set to R. Here, x indicates a variable of the horizontal direction, y indicates a variable of the vertical direction, and z indicates a variable of the channel direction. The dimensionalities of x, y, and z are assumed to be X, Y, and Z, respectively. Bit accuracy of one element is assumed to be B bits. For example, when the input image I(x, y, z) is a gray image, Z=1. When the input image I(x, y, z) is an RGB image, Z=3. The compression parameter R is a parameter with which a desired encoded data size (a target size) can be determined. In the embodiment, for example, the compression parameter R is assumed to be a parameter indicating a compression ratio and taking a value in the range of 0<R≤1. The compression ratio is a ratio calculated by the encoded data size/the size of the input image I(x, y, z).

The feature amount extraction unit 110 extracts a feature amount F(x, y, z) by performing a feature amount extraction process on the input image I(x, y, z) using the compression parameter R as a parameter (step S101). Here, the dimensionalities of x, y, and z are assumed to be X′, Y′, and Z′, respectively. In the feature amount extraction process, for example, the neural network described above and illustrated in FIG. 2 is used.

The quantization unit 120 transforms the feature amount F(x, y, z) into a 1-dimensional vector in a predetermined order. Then, the quantization unit 120 generates the provisional encoded data by performing the quantization process so that each element has a predetermined bit accuracy B′ (step S102).

The encoded data extraction unit 130 obtains the encoded data by extracting data corresponding to the encoded data size calculated from the compression parameter R from the head of the provisional encoded data (step S103).

The binarization unit 140 obtains the bit stream by binarizing the encoded data (step S104).

### [Operation of Decoding Apparatus 200]

Hereinafter, an operation of the decoding apparatus 200 will be described giving a specific example.

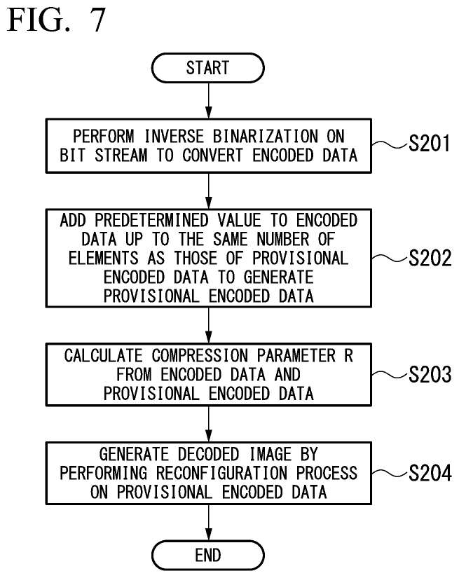

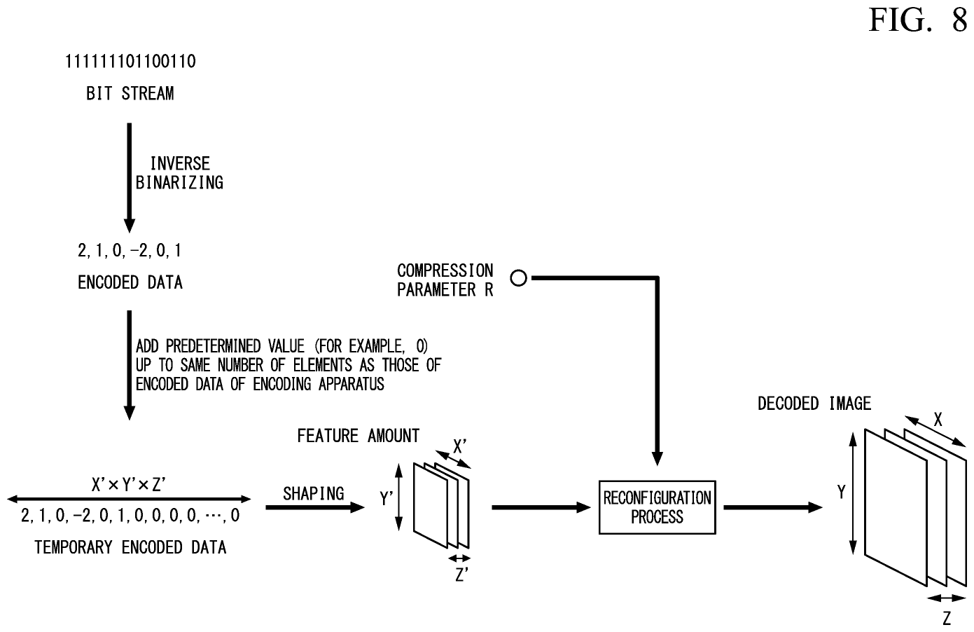

FIG. 7 is a flowchart illustrating an operation of the decoding apparatus 200 according to the embodiment of the present invention. FIG. 8 is a schematic diagram illustrating a flow of a decoding process performed by the decoding apparatus 200 according to the embodiment of the present invention.

The inverse binarization unit 210 performs the inverse binarization on the bit stream to convert the bit stream into the encoded data (step S201).

The encoded data decompression unit 220 decompresses the encoded data until the same number of elements as those of the provisional encoded data of the encoding apparatus 100 to generate the provisional encoded data (a converted feature amount). Specifically, the encoded data decompression unit 220 (a conversion unit) adds a predetermined value (for example, 0 as illustrated in FIG. 8) to the encoded data by the number of deficient elements (step S202).

The compression parameter calculation unit 230 calculates the compression parameter R based on the encoded data and the provisional encoded data. Specifically, the compression parameter calculation unit 230 calculates a data size (that is, X×Y×Z×B) of the decoded image corresponding to the encoded data. Then, the compression parameter calculation unit 230 calculates the compression parameter R as R=(X′×Y′×Z′×B′)/(X×Y×Z×B) (step S203).

The reconfiguration unit 240 shapes the provisional encoded data with an input size of the reconfiguration process. Then, the reconfiguration unit 240 generate a decoded image I′(x, y, z) by performing the reconfiguration process on the provisional encoded data using the compression parameter R as a parameter (step S204). As the reconfiguration process, for example, the neural network described above and illustrated in FIG. 4 is used.

The dimensionality of the feature amount designed so that X×Y×Z×B=X'×Y'×Z′×B′ is satisfied is the best. However, this is not an essential condition. For example, the dimensionality of the feature amount may be designed so that X×Y×Z×B>X′×Y′×Z′×B′ is satisfied. In this case, the maximum value of the compression parameter R which can be input has an upper limit.

The binarized bit stream (encoded data) may be configured to be subjected to entropy coding. In this case, by feeding back a code amount after the entropy coding, it is possible to perform rate control. For example, when a result obtained by dividing an image into blocks, encoding a certain block at a compression ratio of 0.5 (50%), and performing the entropy coding becomes, for example, 0.4, the entire rate control can be performed, for example, by performing the encoding on subsequent blocks at a compression ratio of, for example, 0.6.

### [Flow of Learning Process]

Next, a learning method in a neural network that configures the feature amount extraction unit 110 (a feature amount extraction learning unit) and the reconfiguration unit 240 (a decoding learning unit) according to the embodiment will be described. Here, the neural network is an autoencoder and learning is performed so that a decoded image determined to be the same image as an input image can be obtained. Learning in the feature amount extraction unit 110 and learning in the reconfiguration unit 240 are performed simultaneously.

As preliminary preparation of the learning process, a data set in which a set of the input image I(x, y, z) and the compression parameter R is sample data is prepared. The compression parameter R is set to a random value of a uniform distribution from values which the compression parameter R can take. First, the bit stream of the input image I(x, y, z) is obtained through the encoding process in the above-described encoding apparatus 100. Then, the decoded image is obtained from the bit stream through the decoding process by the above-described decoding apparatus 200. Subsequently, a loss value loss is calculated using a loss function defined by the following Expression (1).

loss=ΣxΣyΣzdiff(I(x, y, z), I′(x, y, z)) (1)

Here, diff(a, b) is a function (for example, a square error or the like) that estimates a distance between a and b. The loss function defined in the foregoing Expression (1) is exemplary. Only a partial error may be calculated or another error term may be added.

Parameters of the feature amount extraction unit 110 and the reconfiguration unit 240 are updated using the calculated loss value loss by a backward error propagation method. The learning in the neural network that configures the feature amount extraction unit 110 and the reconfiguration unit 240 is performed by circulating the foregoing series of flows once and repeating the series of flows using a plurality of pieces of sample data a given number of times or until the loss value loss converges.

As described above, the encoding apparatus 100 and the decoding apparatus 200 according to the embodiment of the present invention perform the feature amount extraction process and the reconfiguration process using the compression parameter as a parameter. The encoding apparatus 100 and the decoding apparatus 200 extracts necessary data corresponding to the encoded data size (the data range corresponding to the target size) from the head in the learning, embeds a range outside the encoded data size (a data range outside of the data range corresponding to the target size) in a predetermined value (for example, 0), and then decodes the encoded data. In such a configuration, when the encoding apparatus 100 and the decoding apparatus 200 compress an image (transforms into low-dimension), the learning is performed so that the parameter expressing a main feature of the image becomes dense in a desired data range in the compressed data (for example, an element corresponding to the necessary encoded data size from the head of the encoded data) (that is, features that determine the image are contained more).

Therefore, in the encoding apparatus 100 and the decoding apparatus 200 according to the embodiment of the present invention, the same effect obtained when an autoencoder system is individually designed with a plurality of encoded data sizes can be achieved with one system. It is not necessary to perform encoding and decoding processes several times as in Non-Patent Literature 1 of the related art and an overhead as in Non-Patent Literature 2 of the related art is not necessary. Thus, in the encoding apparatus 100 and the decoding apparatus 200 according to the embodiment of the present invention, it is possible to compress data to a desired size while inhibiting an increase in a processing time and deterioration in encoding efficiency.

Some or all of the encoding apparatus 100 and the decoding apparatus 200 according to the above-described embodiment may be realized by a computer. In this case, a program for realizing the functions may be recorded on a computer-readable recording medium and the program recorded on the recording medium may be read and executed on a computer system to be realized. The “computer system” mentioned here is assumed to include an OS or hardware such as peripheral devices. The “computer-readable recording medium” is a portable medium such as a flexible disc, a magneto-optical disk, a ROM, or a CD-ROM or a storage device such as a hard disk contained in a computer system. Further, the “computer-readable recording medium” may include a medium that retains the program dynamically in a short time, as in a communication line in the case of transmission of the program via a network such as the Internet or a communication line such as a telephone line, and a medium that retains the program for a given time, such as a volatile memory inside a computer system serving as a server or a client in that case. The program may be a program for realizing some of the above-described functions, may be a program realized by combining the above-described functions with a program already recorded on a computer system, or may be a program realized using hardware such as a programmable logic device (PLD) or a field programmable gate array (FPGA).

The embodiments of the present invention have been described above with reference to the drawings, but the embodiments are merely examples of the present invention and it is apparent that the present invention is not limited to the embodiments.

Accordingly, addition, omission, substitution, and other change of the constituent elements can be made within the scope of the present invention without departing from the technical spirit and gist of the present invention.

### REFERENCE SIGNS LIST

100 Encoding apparatus

110 Feature amount extraction unit

111 Size expansion unit

112 Binding unit

115-1 to 115-N Convolution unit

116-1 to 116-N Downsampling unit

117-1 to 117-N Nonlinear conversion unit

120 Quantization unit

130 Encoded data extraction unit

140 Binarization unit

200 Decoding unit

210 Inverse binarization unit

220 Encoded data decompression unit

230 Compression parameter calculation unit

240 Reconfiguration unit

241 Size expansion unit

242 Binding unit

245-1 to 245-M Inverse convolution unit

246-1 to 246-M Nonlinear conversion unit

1. An encoding apparatus that encodes an input image, the encoding apparatus comprising:
a processor; and
a storage medium having computer program instructions stored thereon, wherein the computer program instructions, when executed by the processor, perform to:
obtain provisional encoded data which has a size greater than a target size of encoded data which is data obtained by encoding the image based on the image and a parameter for determining the target size;
obtain the encoded data by converting data within a data range outside of a data range corresponding to the target size in the provisional encoded data into a predetermined value; and
obtain the provisional encoded data so that features for determining the image are contained more within the data range corresponding to the target size than in the data range outside of the data range corresponding to the target size.

2. The encoding apparatus according to claim 1, wherein a value of the parameter is a code amount or a compression ratio.

3. The encoding apparatus according to claim 1, wherein the computer program instructions further perform to:
delete the data within the data range outside of the data range corresponding to the target size in the provisional encoded data and set data from which the data is deleted as the encoded data to be decoded.

4. A decoding apparatus that decodes an encoded image encoded by an encoding apparatus that acquires provisional encoded data which has a size greater than a target size of encoded data which is data obtained by encoding a first image based on the first image and a parameter for determining the target size and contains more features for determining the first image within a data range corresponding to the target size than a data range outside of the data range corresponding to the target size, and obtains the encoded data by converting data within the data range outside of the data range corresponding to the target size in the provisional encoded data into a predetermined value, the decoding apparatus comprising:
a processor; and
a storage medium having computer program instructions stored thereon, wherein the computer program instructions, when executed by the processor, perform to:
obtain a decoded image from encoded data corresponding to a second image different from the first image based on the encoded data and the parameter.

5. An encoding system comprising:
a feature amount extraction learning unit configured to learn extraction of a feature amount which is a based on an image and a parameter for determining a target size of encoded data which is data obtained by encoding the image so that features for determining the image are contained more in a data range corresponding to the target size than in a data range having a size greater than the target size and being outside of the data range corresponding to the target size;
a conversion unit configured to obtain a conversion feature amount by converting data within the data range outside of the data range corresponding to the target size into a predetermined value with regard to the feature amount; and
a decoding learning unit configured to learn reconfiguration of the image so that a decoded image determined to be the same image as the image is obtained based on the conversion feature amount and the parameter,
wherein each of the feature amount extraction learning unit, the conversion unit and the decoding learning unit is implemented by:
i) computer executable instructions executed by at least one processor,
ii) at least one circuity or
iii) a combination of computer executable instructions executed by at least one processor and at least one circuity.

6. An encoding apparatus that encodes input data to be encoded, the encoding apparatus comprising:
a processor; and
a storage medium having computer program instructions stored thereon, wherein the computer program instructions, when executed by the processor, perform to:
obtain provisional encoded data which has a size greater than a target size of encoded data which is data obtained by encoding the data to be encoded based on the data to be encoded and a parameter for determining the target size;
obtain the encoded data by converting data within a data range outside of a data range corresponding to the target size in the provisional encoded data into a predetermined value; and
obtain the provisional encoded data so that features for determining the data to be encoded are contained more within the data range corresponding to the target size than in the data range outside of the data range corresponding to the target size.

7. A learning method comprising:
learning extraction of a feature amount which is a based on an image and a parameter for determining a target size of encoded data which is data obtained by encoding the image so that features for determining the image are contained more in a data range corresponding to the target size than in a data range having a size greater than the target size and being outside of the data range corresponding to the target size;
obtaining a conversion feature amount by converting data within the data range outside of the data range corresponding to the target size into a predetermined value with regard to the feature amount; and
learning reconfiguration of the image so that a decoded image determined to be the same image as the image is obtained based on the conversion feature amount and the parameter.

8. A non-transitory computer readable medium which stores a program causing a computer to function as the encoding apparatus according to claim 1.

9. A non-transitory computer readable medium which stores a program causing a computer to function as the decoding apparatus according to claim 4.
